(19) United States
(12) Patent Application Publication
(10) Pub. No.: US 2025/0354722 A1
(43) Pub. Date: Nov. 20, 2025

(54) SYSTEM AND METHOD FOR DETERMINING HEAT TRANSFER CAPACITY OF AN INDIRECT WATER HEATER

(71) Applicant: Laars Heating Systems Company, Rochester, NH (US)

(72) Inventors: Lou VORSTEVELD, Derry, NH (US); Steven HUNTING, Rollinsford, NH (US)

(73) Assignee: Laars Heating Systems Company, Rochester, NH (US)

(21) Appl. No.: 18/869,458

(22) PCT Filed: May 31, 2023
(86) PCT No.: PCT/US2023/024000

§ 371 Date: Nov. 26, 2024

Related U.S. Application Data
(60) Provisional application No. 63/347,657, filed on Jun. 1, 2022.

(51) Int. Cl. F24H 15/36; F24D 3/08; F24D 19/10; F24H 15/148; F24H 15/215; F24H 15/219; F24H 15/238; F24H 15/31; F24H 15/335; F24H 15/429

(52) U.S. Cl. CPC F24H 15/36; F24D 3/08; F24D 19/1069; F24H 15/148; F24H 15/215; F24H 15/219; F24H 15/238; F24H 15/31; F24H 15/335; F24H 15/429

(57) ABSTRACT

A water heater system including a boiler having a heat exchanger and an indirect water heater having a heat exchanger, and a controller configured to activate a pump such that the water flows between the boiler heat exchanger and the indirect water heater heat exchanger, and to control a heat source to provide heat to the boiler at a firing rate. The water heater system measuring temperatures of the water at the boiler water inlet and at the boiler water outlet, calculating an amount of heat transfer from the boiler heat exchanger to the indirect water heater exchanger based on the measured temperatures, and adjusting the firing rate based on the calculated amount of heat transfer to determine a heat transfer capacity of the indirect water heater exchanger.

### CROSS REFERENCE TO RELATED APPLICATIONS

This application claims priority from U.S. Provisional Application Ser. No. 63/347,657, titled SYSTEM AND METHOD FOR DETERMINING HEAT TRANSFER CAPACITY OF AN INDIRECT WATER HEATER, filed Jun. 1, 2022, incorporated herein by reference in its entirety for all purposes.

### FIELD OF THE INVENTION

This disclosure relates to system and method that determines heat transfer capacity of an indirect water heater.

### BACKGROUND OF THE INVENTION

A conventional indirect water heater system includes a boiler and a water heater having a heat exchanger plumbed to the boiler inlet/outlet. During operation, cold water is supplied to the indirect water heater via a cold water inlet. The indirect water heater does not include a heat source, as does a traditional water heater, but rather includes a heat exchanger where the water flowing through the heat exchanger is heated by the boiler heat source (e.g. gas burner) and is pumped through the indirect water heater heat exchanger via piping. During an active hot water heat demand from the indirect water heater, heat from the boiler water in the heat exchanger is transferred (e.g. via conduction) to the water stored in the indirect water heater and then supplied to the end user through the hot water outlet. In conventional indirect water heater systems, the boiler controller fires the boiler at a firing rate that typically exceeds the heat transfer capacity of the heat exchanger thereby resulting in wasted fuel.

### SUMMARY OF THE INVENTION

A water heater system comprising a boiler including a boiler water inlet fluidly connected to a boiler water outlet via a boiler heat exchanger internal to the boiler, a heat source providing heat to the boiler heat exchanger, an indirect water heater, separate from the boiler, including an indirect water heater water inlet fluidly connected to an indirect water heater water outlet via an indirect water heater heat exchanger internal to the indirect water heater, where the boiler water outlet is fluidly connected to the indirect water heater water inlet, and the indirect water heater water outlet is fluidly connected to the boiler water inlet, such that water flows between the boiler heat exchanger and the indirect water heater exchanger, and a controller configured to control the heat source by activating a pump such that the water flows between the boiler heat exchanger and the indirect water heater exchanger, controlling the heat source to provide heat to the boiler heat exchanger at a firing rate, measuring temperatures of the water at the boiler water inlet and at the boiler water outlet, calculating an amount of heat transfer from the boiler heat exchanger to the indirect water heater exchanger based on the measured temperatures, and adjusting the firing rate based on the calculated amount of heat transfer to determine a heat transfer capacity of the indirect water heater exchanger.

A method for controlling a heat source to provide heat to a boiler heat exchanger of a boiler of a water heater system including an indirect water heater, separate from the boiler, including an indirect water heater water inlet fluidly connected to an indirect water heater water outlet via an indirect water heater heat exchanger internal to the indirect water heater, where the boiler water outlet is fluidly connected to the indirect water heater water inlet, and the indirect water heater water outlet is fluidly connected to the boiler water inlet, such that water flows between the boiler heat exchanger and the indirect water heater exchanger. The method includes activating a pump such that water flows between the boiler heat exchanger and an indirect water heater exchanger of an indirect water heater, controlling the heat source to provide heat to the boiler heat exchanger at a firing rate, measuring temperatures of the water at a boiler water inlet of the boiler and at a boiler water outlet of the boiler, calculating an amount of heat transfer from the boiler heat exchanger to the indirect water heater exchanger based on the measured temperatures, and adjusting the firing rate based on the calculated amount of heat transfer to determine a heat transfer capacity of the indirect water heater exchanger.

### BRIEF DESCRIPTION OF THE DRAWINGS

The drawing figures depict one or more implementations, by way of example only, not by way of limitation. In the figures, like reference numerals refer to the same or similar elements.

FIG. 1 is a block diagram of an embodiment of a plumbing configuration of an indirect water heater system according to an aspect of the disclosure.

FIG. 2 is block diagram of an embodiment of an electrical configuration of an indirect water heater system according to an aspect of the disclosure.

FIG. 3 is a flowchart describing an operation of an embodiment of an indirect water heater system according to an aspect of the disclosure.

FIG. 4 is another flowchart describing an operation of an embodiment of an indirect water heater system according to an aspect of the disclosure.

### DETAILED DESCRIPTION OF EMBODIMENTS OF THE INVENTION

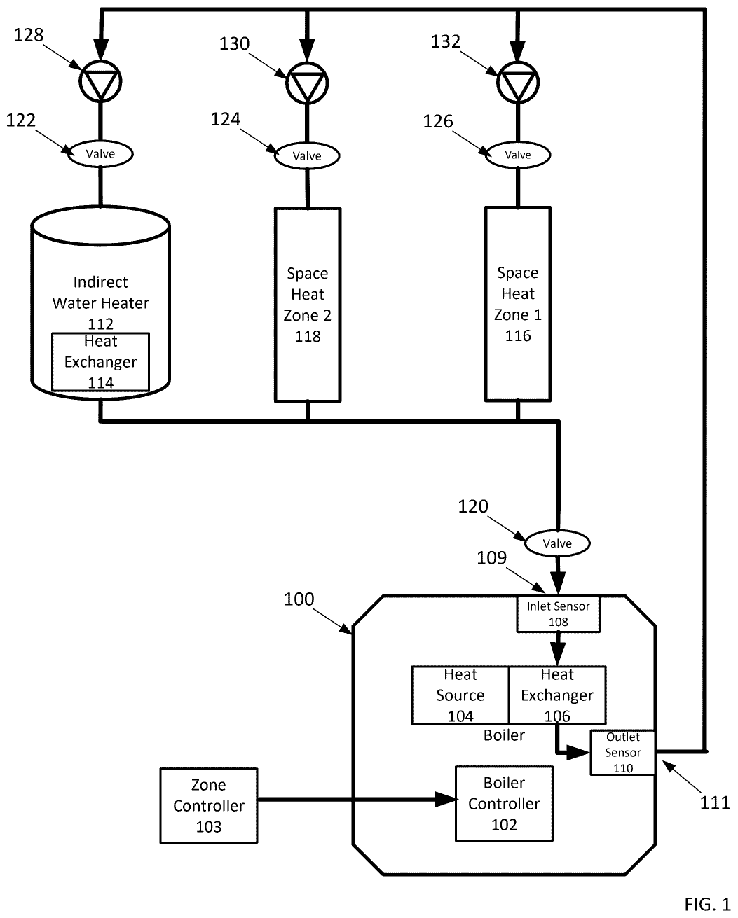

FIG. 1 is a block diagram of an embodiment of a plumbing configuration of an indirect water heater system. Included in the system is boiler 100 and indirect water heater 112 which are plumbed together via pipes. In addition to indirect water heater 112, other heater appliances such as hydronic space heat radiators in one or more space heat zones 116 and 118 may also be plumbed with the boiler and indirect water heater 112. During operation, boiler 100 is triggered to produce hot water in response to a space heating heat demand signal received from zone controller 103 which is connected to one or more thermostats (not shown) and connected to zone pumps for space heat zone 116 and/or space heat zone 118. The indirect hot water heater is controlled by either an aquastat or DHW sensor and pump 128, all connected to boiler controller 102. Upon being triggered by zone controller 103, boiler controller 102 controls the heat source 104 (e.g. gas burner, electric element, etc.) to fire and heat water in boiler heat exchanger 106. In the case of a gas burner, a valve may release the gas, at which point a burner fan (not shown) applies positive air pressure to the system to suck an amount of gas from the valve that is proportional the burner fan speed (e.g. if the firing rate is high, then the fan speed will be high and the amount of gas sucked out and ignited will be high thereby producing high heat for the boiler. If the firing rate is low, then the fan speed will be low and the amount of gas sucked out and ignited will be low thereby producing low heat for the boiler). It is noted that the BTU output of the boiler may be determined by burner fan speed (e.g. BTU output of the boiler is correlated to burner fan speed). During this procedure, zone controller 103 controls one or more of pumps 130 and/or 132 to start pumping the heated water from boiler outlet 111 through the piping and appliances and back to boiler inlet 109. Valves 120, 122, 124 and 126 may also be controlled by zone controller 103, or they may be manual valves that are normally open. For example, if a heat demand is received from indirect water heater 112, boiler controller 102 fires heat source 104 and boiler controller 102 turns on pump 128 to force hot water from the boiler outlet 111 to heat exchanger 114 of indirect water heater 112. If a heat demand is received from space heat zone 116, boiler controller 102 fires heat source 104 and zone controller 103 turns on pump 132 to force hot water from the boiler outlet 111 to radiators (not shown) in space heat zone 116. Likewise, if a heat demand is received from space heat zone 118, boiler controller 102 fires heat source 104 and zone controller 103 turns on pump 130 to force hot water from the boiler outlet 111 to radiators (not shown) in space heat zone 118. In either case, once the heat demands are satisfied boiler controller 102 is able to reduce or turn off the firing rate of heat source 104 independently, or in response to a shutoff command from zone controller 103.

Generally, boiler 100 can supply hot water to indirect water heater 112, space heat zone 116 and space heat zone 118 one at a time or simultaneously by controlling the firing rate of the heat source 104 and the operational state of pumps 130-132 with the aid of zone controller 103. Firing rate generally dictates the amount of heat produced by heat source 104 (e.g. gas flow volume for a gas burner, electrical current flowing through an electric heater element, etc.). This may be measured in percentage of a maximum amount of heat that can be produced from heat source 104 (e.g. 0%-100%).

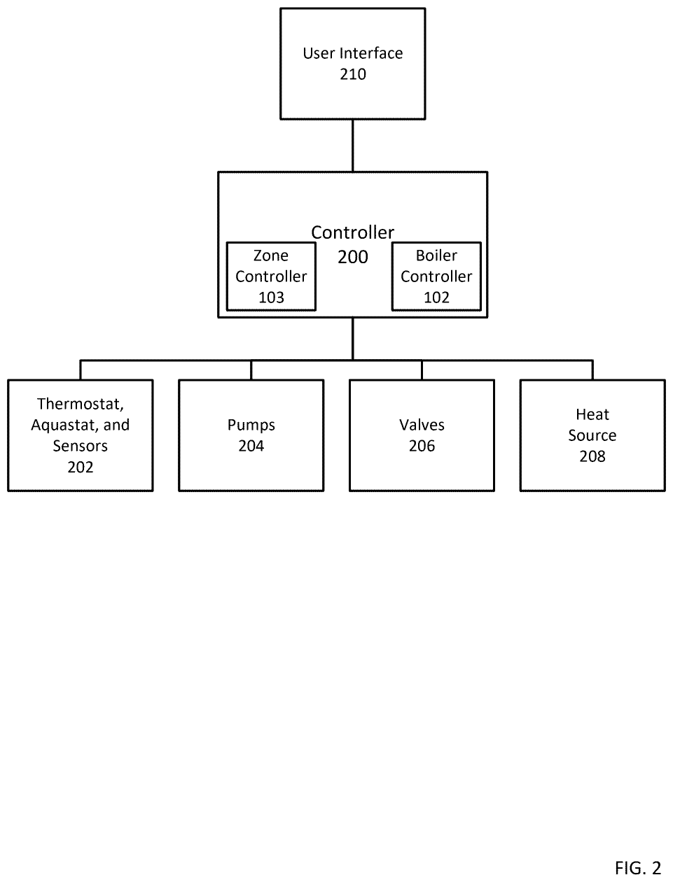

FIG. 2 is block diagram of an embodiment of an electrical configuration of the indirect water heater system shown in FIG. 1. In general, controller 200, which includes a separate or a combined boiler controller 102 and zone controller 103 may include a processor and other supporting electronic devices such as memory, input/output ports, etc., may be connected to various electrical devices (e.g. pumps, thermostats, etc.) for supporting the control of the water heater system shown in FIG. 1. For example, controller 200 may be electrically connected via electrical wires to thermostats and sensors 202 (e.g. thermostats of the indirect water heater, thermostats of the space heat zones, inlet/outlet temperature/flow sensors of the boiler), pumps 204, water valves 206 and heat source 208 and user interface 210 (e.g. display screen, indicator lights, buttons, etc.). These electrical connections allow controller 200 to receive/send electrical signals to/from the various electrical devices throughout the system.

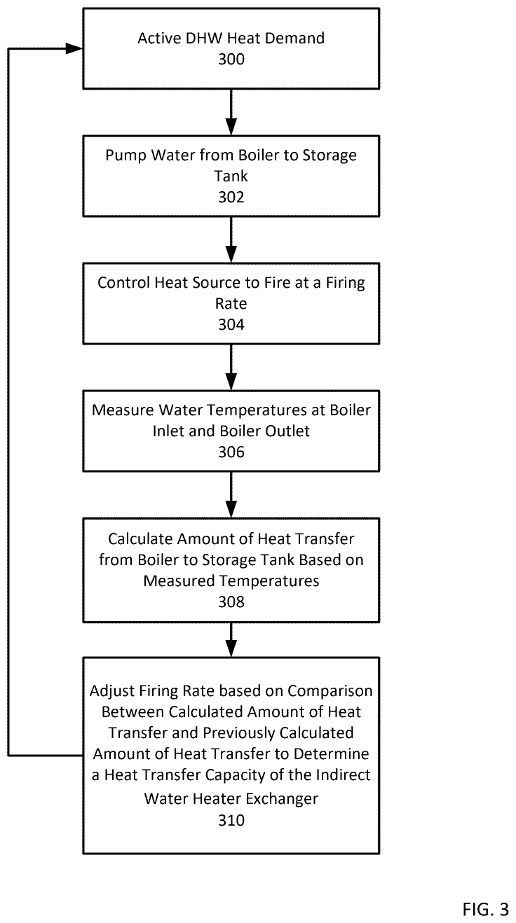

FIG. 3 is a flowchart describing an operation of an embodiment of an indirect water heater system shown in FIGS. 1 and 2. In this example, in step 300, an active heat demand, herein referred to as a domestic hot water (DHW) heat demand, is received from indirect water heater 112 (e.g. the aquastat or DHW sensor of indirect water heater 112 sends a signal to boiler controller 102 requesting heat). In response to receiving this DHW heat demand signal, in step 302, boiler controller turns ON pump 128 to begin pumping water from the boiler outlet 111 to heat exchanger 114 of indirect water heater 112. In step 304, boiler controller 102 controls heat source 104 to fire at a specified firing rate (e.g. anywhere from 0%-100%). In step 306, boiler controller 102 measures the water temperatures and flow rates via sensors 108 and 100 at boiler inlet 109 and boiler outlet 111. Based on the measured temperatures and flow rates, boiler controller 102 then, in step 308, calculates an amount of heat transfer from boiler heat exchanger 106 to heat exchanger 114 of indirect water heater 112. The amount of heat transfer is generally based on a temperature differential between the boiler inlet and boiler outlet measured at different times by sensors 108/110 during the heating cycle. Boiler controller 102, in step 310, then adjusts the firing rate by comparing the computed amount of heat transfer to a previously computed amount of heat transfer to determine a heat transfer capacity of the indirect water heater exchanger. In one example, if the computed amount of heat transfer is greater than the previously computed amount of heat transfer, boiler controller 102 determines that the heat transfer capacity of heat exchanger 114 of indirect water heater 112 has not been reached (i.e. the heat exchanger 114 is capable of exchanging more heat), and therefore the firing rate may be increased. In another example, if the computed amount of heat transfer is not greater than the previously computed amount of heat transfer, boiler controller 102 determines that the heat transfer capacity of heat exchanger 114 of indirect water heater 112 has been reached (i.e. the heat exchanger 114 is not capable of exchanging more heat), and therefore the firing rate should not be increased.

In order to determine heat transfer capacity of heat exchanger 114 of indirect water heater 112, the max firing rate can either be set at a low value and then gradually increased, or set at a high value and then gradually decreased.

In one example, the max firing rate may be set at a low value (e.g. 20% boiler capacity) and then gradually increased (e.g. 20%, 30%, 40%, etc.) with each DHW heat demand cycle. As long as the heat transfer capacity of heat exchanger 114 has not been reached, the measured amount of heat transfer will continue to increase with an increase in firing rate. However, once the heat transfer capacity of heat exchanger 114 has been reached, the measured amount of heat transfer will not increase as much and may begin to plateau indicating that heat exchanger 114 cannot transfer anymore heat. This firing rate can then be set as a maximum firing rate for the boiler when responding to future heat demands from indirect water heater 112.

In another example, the max firing rate may be set at a high value (e.g. 80% boiler capacity) and then gradually decreased (e.g. 80%, 70%, 60%, etc.) with each DHW heat demand cycle. As long as the amount of heat produced by the boiler is more than the heat transfer capacity of heat exchanger 114, the measured amount of heat transfer will not decrease with a decrease in firing rate (i.e. heat transfer will remain plateaued). However, once the heat produced by the boiler is less than the heat transfer capacity of heat exchanger 114, the measured amount of heat transfer will begin to decrease indicating that that heat exchanger 114 can transfer more heat. A firing rate just before the measured amount of heat transfer began to decrease can then be set as a maximum firing rate for the boiler when responding to future heat demands from indirect water heater 112.

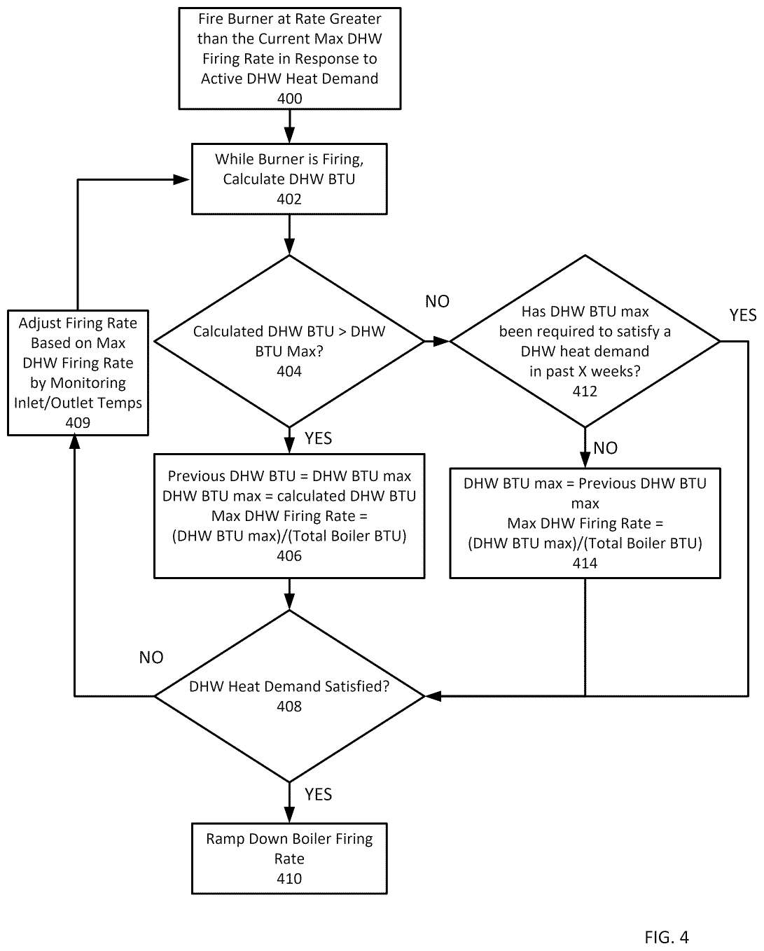

FIG. 4 is another flowchart describing an operation of an embodiment of an indirect water heater system shown in FIGS. 1 and 2. In step 400, boiler controller 102 fires the burner at a rate greater than the current maximum DHW firing rate stored in memory. The current maximum DHW firing rate may initially be a low firing rate (e.g. 20%), for example, described above. In step 402, when the burner is firing, boiler controller 102 computes the DHW BTU based on the flow rate and the temperature differential between the boiler inlet/outlet as shown in the equation below, where the flowrate of the water may be determined by the pump speed, and outlet/inlet temperature may be determined by outlet/inlet temperature sensors:

$$BTU = Flowrate in GPM of water * ( outlet temp - inlet temp ) * 500.4$$

In step 404, boiler controller 102 then compares the calculated DHW BTU to a DHW BTU maximum which may be initially set at a low value and gradually converge to the determined heat transfer capacity of the indirect water heater exchanger. If the calculated DHW BTU is greater than the DHW BTU maximum, then in step 406, the previous DHW BTU max is set equal to the DHW BTU max, the DHW BTU max is set equal to the calculated DHW BTU, and the max DHW firing rate is set equal to (DHW BTU max)/(Total Boiler BTU). Note that Total Boiler BTU is known to boiler controller 102, because the controller knows the boiler model in which it is installed. In contrast, if the calculated DHW BTU is not greater than the DHW BTU maximum, then in step 412 it is determined whether the DHW BTU max has been required to satisfy a DHW heat demand in a predetermined timer period (e.g. past X days/weeks, etc.). If not, then in step 414, the DHW BTU max is set equal to the previous DHW BTU max, and the max DHW firing rate is set as (DHW BTU max)/(Total Boiler BTU). In either case, in step 408, boiler controller 102 determines if the DHW demand is satisfied. If the DHW demand is not satisfied, the firing rate is adjusted (e.g. increased or decreased depending on the algorithm) in step 409 and the flow repeats at step 402. If the DHW demand is satisfied, the boiler is turned OFF in step 410. However, rather than turning the boiler off immediately upon reaching satisfaction of demand (e.g. upon reaching the setpoint temperature of the DHW tank), the boiler controller gradually begins reducing the firing rate as DHW satisfaction is reached/approached. In one example, when the DHW tank has a temperature sensor (not shown), the temperature sensor can be monitored. When the temperature sensor indicates that the DHW tank temperature is approaching setpoint, then the firing rate begins to ramp down such that when setpoint is reached, the system is nearing shutdown. In another example, when the DHW tank does not have a temperature sensor, but rather relies on an aquastat, the boiler controller can determine that the DHW tank temperature is approaching setpoint when the inlet/outlet temperatures begin to converge gradually, at which point the firing rate then begins to ramp down such that when setpoint is reached, the system is nearing shutdown.

It is noted that the steps shown in FIG. 4 are generally performed during a DHW only heat demand (e.g. when there is no space heat demand) to calculate the indirect tank heat exchange capacity. The steps in FIG. 4 generally set the firing rate at a low level (e.g. 20%) and then increase the firing rate until the DHW BTU no longer increases with an increase in firing rate. However, it is noted that the steps shown in FIG. 4 may be modified to fire the burner initially at a high rate (e.g. 80%) which can then be decreased with each cycle until the calculated DHW BTU begins to decrease with a decrease in firing rate. It is also noted that the max firing rate calculations in steps 406/414 are able to differentiate between a temperature drops in the tank due to DHW demand versus temperature drops in the tank when the tank is cold (e.g. tank is initially installed or not fired for a long time). The temperature drops when the tank is cold are generally ignored in the calculation as they could lead to inaccurate results.

The flowcharts described above relate to a DHW demand only scenario where the system learns the heat transfer capacity of the DHW heat exchanger. In a scenario where there is simultaneous DHW demand and hydronic heat demand, the system will not perform learning, but will fire at a rate determined to satisfy both DHW demand and hydronic heat demand. In case of the firing rate exceeding a high threshold (e.g. 90%), the control system will temporarily disable the hydronic pump(s) to prioritize DHW production. Hydronic pump(s) are allowed to run again at a lower firing rate, (e.g. 50%). Essentially, the system would encourage pump(s) to cycle, but allow the burner to modulate to adapt to instantaneous demand without shutting down.

It will be understood that the terms and expressions used herein have the ordinary meaning as is accorded to such terms and expressions with respect to their corresponding respective areas of inquiry and study except where specific meanings have otherwise been set forth herein. For example, the term “coupled” as used herein refers to any logical, optical, physical or electrical connection, link or the like by which signals or light produced or supplied by one system element are imparted to another coupled element. Unless described otherwise, coupled elements or devices are not necessarily directly coupled or connected to one another and may be separated by intermediate components, elements or communication media that may modify, manipulate or carry the signals. Also, the term “coupled” can refer to direct or indirect mechanical or thermal connectedness. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount. The term “substantially” as used herein means the parameter value or the like

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

In the above detailed description, numerous specific details were set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The invention includes, but is not limited to, the following aspects:

1. A water heater system comprising:
a boiler including a boiler water inlet fluidly connected to a boiler water outlet via a boiler heat exchanger internal to the boiler;
a heat source providing heat to the boiler heat exchanger;
an indirect water heater, separate from the boiler, including an indirect water heater water inlet fluidly connected to an indirect water heater water outlet via an indirect water heater heat exchanger internal to the indirect water heater, wherein the boiler water outlet is fluidly connected to the indirect water heater water inlet, and the indirect water heater water outlet is fluidly connected to the boiler water inlet, such that water flows between the boiler heat exchanger and the indirect water heater exchanger; and
a controller configured to control the heat source by:
   activating a pump such that the water flows between the boiler heat exchanger and the indirect water heater exchanger,
   controlling the heat source to provide heat to the boiler heat exchanger at a firing rate,
   measuring temperatures of the water at the boiler water inlet and at the boiler water outlet,
   calculating an amount of heat transfer from the boiler heat exchanger to the indirect water heater exchanger based on the measured temperatures, and
   adjusting the firing rate based on the calculated amount of heat transfer to determine a heat transfer capacity of the indirect water heater exchanger.

2. The water heater system of aspect 1,
wherein the controller is further configured to calculate the amount of heat transfer based on a measured flow rate of the water through the boiler water inlet or the boiler water outlet, and a difference in the measured temperatures.

3. The water heater system of aspect 1,
wherein the controller is further configured to adjust the firing rate based on a comparison of the calculated amount of heat transfer to a previously calculated amount of heat transfer.

4. The water heater system of aspect 1,
wherein the controller is further configured to adjust the firing rate by:
   increasing the firing rate when the calculated amount of heat transfer is greater than the previously calculated amount of heat transfer, and
   maintaining the firing rate when the calculated amount of heat transfer is the same as the previously calculated amount of heat transfer.

5. The water heater system of aspect 1,
wherein the controller is further configured to determine a heat transfer capacity of the indirect water heater upon installation of the indirect water heater, and periodically after the installation.

6. The water heater system of aspect 1,
wherein the controller is further configured to adjust the firing rate by:
   initially setting the firing rate based on a minimum heat capacity of the boiler, and
   gradually increasing the firing rate until the calculated amount of heat transfer of the indirect water heater plateaus.

7. The water heater system of aspect 1,
wherein the controller is further configured to adjust the firing rate by:
   initially setting the firing rate based on a maximum heat capacity of the boiler, and
   gradually decreasing the firing rate until the calculated amount of heat transfer of the indirect water heater begins to decrease.

8. The water heater system of aspect 1,
wherein the controller is further configured to set the adjusted firing rate as a maximum firing rate of the indirect water heater.

9. The water heater system of aspect 1, further comprising:
a hydronic space heating system including a hydronic space heating water inlet fluidly connected to the boiler water outlet, and a hydronic space heating water outlet fluidly connected to the boiler water inlet, such that water flows between the boiler heat exchanger and the hydronic space heating system;
wherein the controller is further configured to adjust the firing rate based on a simultaneous heat demand from the hydronic space heating system and the indirect water heater.

10. The water heater system of aspect 9,
wherein the controller is further configured to control valves or pumps to divert water to the hydronic space heating system while ensuring that the heat transfer capacity of the indirect water heater is satisfied.

11. A method for controlling a heat source to provide heat to a boiler heat exchanger of a boiler of a water heater system including an indirect water heater, separate from the boiler, including an indirect water heater water inlet fluidly connected to an indirect water heater water outlet via an indirect water heater heat exchanger internal to the indirect water heater, wherein the boiler water outlet is fluidly connected to the indirect water heater water inlet, and the indirect water heater water outlet is fluidly connected to the boiler water inlet, such that water flows between the boiler heat exchanger and the indirect water heater exchanger, the method comprising:
activating a pump such that water flows between the boiler heat exchanger and an indirect water heater exchanger of an indirect water heater,
controlling the heat source to provide heat to the boiler heat exchanger at a firing rate,
measuring temperatures of the water at a boiler water inlet of the boiler and at a boiler water outlet of the boiler,
calculating an amount of heat transfer from the boiler heat exchanger to the indirect water heater exchanger based on the measured temperatures, and
adjusting the firing rate based on the calculated amount of heat transfer to determine a heat transfer capacity of the indirect water heater exchanger.

12. The method of aspect 11, further comprising:
calculating the amount of heat transfer based on a measured flow rate of the water through the boiler water inlet or the boiler water outlet, and a difference in the measured temperatures.

13. The method of aspect 11, further comprising:
adjusting the firing rate based on a comparison of the calculated amount of heat transfer to a previously calculated amount of heat transfer.

14. The method of aspect 11, further comprising:
increasing the firing rate when the calculated amount of heat transfer is greater than the previously calculated amount of heat transfer, and
maintaining the firing rate when the calculated amount of heat transfer is the same as the previously calculated amount of heat transfer.

15. The method of aspect 11, further comprising:
determining a heat transfer capacity of the indirect water heater upon installation of the indirect water heater, and periodically after the installation.

16. The method of aspect 11, further comprising:
initially setting the firing rate based on a minimum heat capacity of the boiler, and
gradually increasing the firing rate until the calculated amount of heat transfer of the indirect water heater plateaus.

17. The water heater system of aspect 11, further comprising:
initially setting the firing rate based on a maximum heat capacity of the boiler, and
gradually decreasing the firing rate until the calculated amount of heat transfer of the indirect water heater begins to decrease.

18. The method of aspect 11, further comprising:
setting the adjusted firing rate as a maximum firing rate of the indirect water heater.

19. The method of aspect 1, further comprising:
a hydronic space heating system including a hydronic space heating water inlet fluidly connected to the boiler water outlet, and a hydronic space heating water outlet fluidly connected to the boiler water inlet, such that water flows between the boiler heat exchanger and the hydronic space heating system;
adjusting the firing rate based on heat demand from a hydronic space heating system of the water heater system and the heat transfer capacity of the indirect water heater.

20. The method of aspect 19, further comprising:
controlling valves to divert water to the hydronic space heating system while ensuring that the heat transfer capacity of the indirect water heater is satisfied.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed:

1. A water heater system comprising:
a boiler including a boiler water inlet fluidly connected to a boiler water outlet via a boiler heat exchanger internal to the boiler;
a heat source providing heat to the boiler heat exchanger;
an indirect water heater, separate from the boiler, including an indirect water heater water inlet fluidly connected to an indirect water heater water outlet via an indirect water heater heat exchanger internal to the indirect water heater, wherein the boiler water outlet is fluidly connected to the indirect water heater water inlet, and the indirect water heater water outlet is fluidly connected to the boiler water inlet, such that water flows between the boiler heat exchanger and the indirect water heater exchanger; and
a controller configured to control the heat source by:
activating a pump such that the water flows between the boiler heat exchanger and the indirect water heater exchanger,
controlling the heat source to provide heat to the boiler heat exchanger at a firing rate,
measuring temperatures of the water at the boiler water inlet and at the boiler water outlet,
calculating an amount of heat transfer from the boiler heat exchanger to the indirect water heater exchanger based on the measured temperatures, and
adjusting the firing rate based on the calculated amount of heat transfer to determine a heat transfer capacity of the indirect water heater exchanger.

2. The water heater system of claim 1,
wherein the controller is further configured to calculate the amount of heat transfer based on a measured flow rate of the water through the boiler water inlet or the boiler water outlet, and a difference in the measured temperatures.

3. The water heater system of claim 1,
wherein the controller is further configured to adjust the firing rate based on a comparison of the calculated amount of heat transfer to a previously calculated amount of heat transfer.

4. The water heater system of claim 1,
wherein the controller is further configured to adjust the firing rate by:
increasing the firing rate when the calculated amount of heat transfer is greater than the previously calculated amount of heat transfer, and
maintaining the firing rate when the calculated amount of heat transfer is the same as the previously calculated amount of heat transfer.

5. The water heater system of claim 1,
wherein the controller is further configured to determine a heat transfer capacity of the indirect water heater upon installation of the indirect water heater, and periodically after the installation.

6. The water heater system of claim 1,
wherein the controller is further configured to adjust the firing rate by:
initially setting the firing rate based on a minimum heat capacity of the boiler, and
gradually increasing the firing rate until the calculated amount of heat transfer of the indirect water heater plateaus.

7. The water heater system of claim 1,
wherein the controller is further configured to adjust the firing rate by:
initially setting the firing rate based on a maximum heat capacity of the boiler, and
gradually decreasing the firing rate until the calculated amount of heat transfer of the indirect water heater begins to decrease.

8. The water heater system of claim 1,
wherein the controller is further configured to set the adjusted firing rate as a maximum firing rate of the indirect water heater.

9. The water heater system of claim 1, further comprising:
a hydronic space heating system including a hydronic space heating water inlet fluidly connected to the boiler water outlet, and a hydronic space heating water outlet fluidly connected to the boiler water inlet, such that water flows between the boiler heat exchanger and the hydronic space heating system;
wherein the controller is further configured to adjust the firing rate based on a simultaneous heat demand from the hydronic space heating system and the indirect water heater.

10. The water heater system of claim 9,
wherein the controller is further configured to control valves or pumps to divert water to the hydronic space heating system while ensuring that the heat transfer capacity of the indirect water heater is satisfied.

11. A method for controlling a heat source to provide heat to a boiler heat exchanger of a boiler of a water heater system including an indirect water heater, separate from the boiler, including an indirect water heater water inlet fluidly connected to an indirect water heater water outlet via an indirect water heater heat exchanger internal to the indirect water heater, wherein the boiler water outlet is fluidly connected to the indirect water heater water inlet, and the indirect water heater water outlet is fluidly connected to the boiler water inlet, such that water flows between the boiler heat exchanger and the indirect water heater exchanger, the method comprising:
activating a pump such that water flows between the boiler heat exchanger and an indirect water heater exchanger of an indirect water heater,
controlling the heat source to provide heat to the boiler heat exchanger at a firing rate,
measuring temperatures of the water at a boiler water inlet of the boiler and at a boiler water outlet of the boiler,
calculating an amount of heat transfer from the boiler heat exchanger to the indirect water heater exchanger based on the measured temperatures, and
adjusting the firing rate based on the calculated amount of heat transfer to determine a heat transfer capacity of the indirect water heater exchanger.

12. The method of claim 11, further comprising:
calculating the amount of heat transfer based on a measured flow rate of the water through the boiler water inlet or the boiler water outlet, and a difference in the measured temperatures.

13. The method of claim 11, further comprising:
adjusting the firing rate based on a comparison of the calculated amount of heat transfer to a previously calculated amount of heat transfer.

14. The method of claim 11, further comprising:
increasing the firing rate when the calculated amount of heat transfer is greater than the previously calculated amount of heat transfer, and
maintaining the firing rate when the calculated amount of heat transfer is the same as the previously calculated amount of heat transfer.

15. The method of claim 11, further comprising:
determining a heat transfer capacity of the indirect water heater upon installation of the indirect water heater, and periodically after the installation.

16. The method of claim 11, further comprising:
initially setting the firing rate based on a minimum heat capacity of the boiler, and
gradually increasing the firing rate until the calculated amount of heat transfer of the indirect water heater plateaus.

17. The water heater system of claim 11, further comprising:
initially setting the firing rate based on a maximum heat capacity of the boiler, and
gradually decreasing the firing rate until the calculated amount of heat transfer of the indirect water heater begins to decrease.

18. The method of claim 11, further comprising:
setting the adjusted firing rate as a maximum firing rate of the indirect water heater.

19. The method of claim 1, further comprising:
a hydronic space heating system including a hydronic space heating water inlet fluidly connected to the boiler water outlet, and a hydronic space heating water outlet fluidly connected to the boiler water inlet, such that water flows between the boiler heat exchanger and the hydronic space heating system;
adjusting the firing rate based on heat demand from a hydronic space heating system of the water heater system and the heat transfer capacity of the indirect water heater.

20. The method of claim 19, further comprising:
controlling valves to divert water to the hydronic space heating system while ensuring that the heat transfer capacity of the indirect water heater is satisfied.
